(19) United States
(12) Patent Application Publication
(10) Pub. No.: US 2014/0210203 A1
(43) Pub. Date: Jul. 31, 2014

(54) Fluid Couplling Assembly with Integral Plug Retainer

(71) Applicant: EATON CORPORATION, CLEVELAND, OH (US)

(72) Inventor: Aaron Michael Lorkowsi, Fairview Park, OH (US)

(73) Assignee: EATON CORPORATION, Cleveland, OH (US)

(21) Appl. No.: 14/168,237

(22) Filed: Jan. 30, 2014

Related U.S. Application Data
(60) Provisional application No. 61/758,920, filed on Jan. 31, 2013.

(51) Int. Cl. F16L 37/18

(52) U.S. Cl. CPC F16L 37/18
USPC 285/88

(57) ABSTRACT

A socket assembly includes a socket body, a plug retainer and a socket sleeve. The socket body defines a bore that extends through the socket body and at least one retention opening that extends into the bore. The plug retainer is operably associated with the socket body. The plug retainer includes a retainer. The plug retainer pivots between an engaged position, in which a portion of the retainer is disposed in the bore of the socket body, and a disengaged position, in which the bore is free of the portion of the retainer. The socket sleeve is disposed about the socket body and is adapted for selective axial movement between a first position and a second position. The socket sleeve actuates the plug retainer to the engaged position in the first position and the disengaged position in the second position.

### CROSS REFERENCE TO RELATED APPLICATION

This application claims the benefit of U.S. Provisional Patent Application Ser. No. 61/758,920, filed on Jan. 31, 2013, the disclosure of which is hereby incorporated by reference in its entirety.

### BACKGROUND

Fluid couplings are used in many hydraulic applications. One type of fluid coupling that is commonly used in high pressure applications (e.g., mining industry applications, etc.) is a staple coupling. Staple couplings typically include a male connector, a female connector and a staple. The staple is generally a U-shaped piece that is made of a hardened material. After the male and female connectors have been joined, the staple is inserted through openings in the female connector so that it engages a groove in the male connector. The staple ensures that the male and female connectors remain engaged despite the increased fluid pressure.

While staple couplings have been used successfully in many applications, staple couplings require the use of tools to insert and remove the staple. In addition, as the staple is a separate piece from the male and female connectors, the use of a staple requires that the operator keep track of the staple during assembly and disassembly of the fluid coupling to ensure proper functioning of the fluid coupling.

### SUMMARY

An aspect of the present disclosure relates to a fluid coupling assembly. The fluid coupling assembly includes a plug and a socket assembly. The plug has a first end portion and a second end portion. The first end portion defines a retention groove. The socket assembly is adapted for selective engagement with the plug. The socket assembly includes a socket body and a plug retainer. The socket body defines a bore that extends through the socket body and defines at least one retention opening that extends into the bore. The at least one retention opening is generally aligned with the retention groove when the first end portion of the plug is inserted into the bore of the socket body. The plug retainer is operably associated with the socket body. The plug retainer has a body that includes a retainer. The plug retainer pivots between an engaged position, in which a portion of the retainer is disposed in the retention groove of the plug, and a disengaged position, in which the retention groove of the plug is free of the portion of the retainer.

Another aspect of the present disclosure relates to a socket assembly of a fluid coupling assembly. The socket assembly includes a socket body, a plug retainer and a socket sleeve. The socket body has an inner surface and an outer surface. The inner surface defines a bore that extends through the socket body. The outer surface defines at least one retention opening that extends through the outer and inner surfaces. The plug retainer is operably associated with the socket body. The plug retainer includes a retainer, a portion of which is disposed in the retention opening of the socket body. The plug retainer pivots between an engaged position, in which a portion of the retainer is disposed in the bore of the socket body, and a disengaged position, in which the bore is free of the portion of the retainer. The socket sleeve is disposed about the socket body and is adapted for selective axial movement between a first position and a second position. The socket sleeve actuates the plug retainer to the engaged position in the first position and the disengaged position in the second position.

Another aspect of the present disclosure relates to a socket assembly of a fluid coupling assembly. The socket assembly includes a socket body, a socket sleeve and a sleeve lock. The socket body has a first portion and an oppositely disposed second portion. The socket body defines a bore that extends axially through the socket body. The socket sleeve is disposed about the socket body. The socket sleeve has a first axial end and an oppositely disposed second axial end. The socket sleeve is adapted for selective axial movement between a first position and a second position. An outer surface of the second portion of the socket body is exposed when the socket sleeve is in the first position. The sleeve lock is disposed in the second portion of the socket body. The sleeve lock is in fluid communication with the bore of the socket body. The sleeve lock includes a piston that extends beyond the outer surface of the second portion in response to pressurized fluid in the bore of the socket body. Abutment of the piston and the second axial end of the socket sleeve prevents actuation of the socket sleeve to the second position when pressurized fluid is in the bore of the socket body.

### DRAWINGS

FIG. 1 is an isometric view of a fluid coupling assembly having exemplary features of aspects in accordance with the principles of the present disclosure.

FIG. 2 is an exploded view of a socket assembly suitable for use with the fluid coupling assembly of FIG. 1.

FIG. 3 is a cross-sectional view of the fluid coupling assembly of FIG. 1.

FIG. 4 is a front view of a socket body suitable for use with the socket assembly of FIG. 2.

FIG. 5 is a cross-sectional view of the socket body taken on line 5-5 of FIG. 4.

FIG. 6 is a front view of a socket sleeve suitable for use with the socket assembly of FIG. 2.

FIG. 7 is a cross-sectional view of the socket sleeve taken on line 7-7 of FIG. 6.

FIG. 8 is an isometric view of a plug retainer suitable for use with the socket assembly of FIG. 2.

FIG. 9 is a cross-sectional view of the plug retainer of FIG. 8.

FIG. 10 is an isometric view of a plug suitable for use with the fluid coupling assembly of FIG. 1.

FIG. 11 is an exploded view of a plug assembly.

FIG. 12 is a cross-sectional view of the fluid coupling assembly showing the plug retainer in the disengaged position.

FIG. 13 is a cross-sectional view of a sleeve lock suitable for use with the fluid coupling assembly.

FIG. 14 is a cross-sectional view of the sleeve lock with a piston in an extended position.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

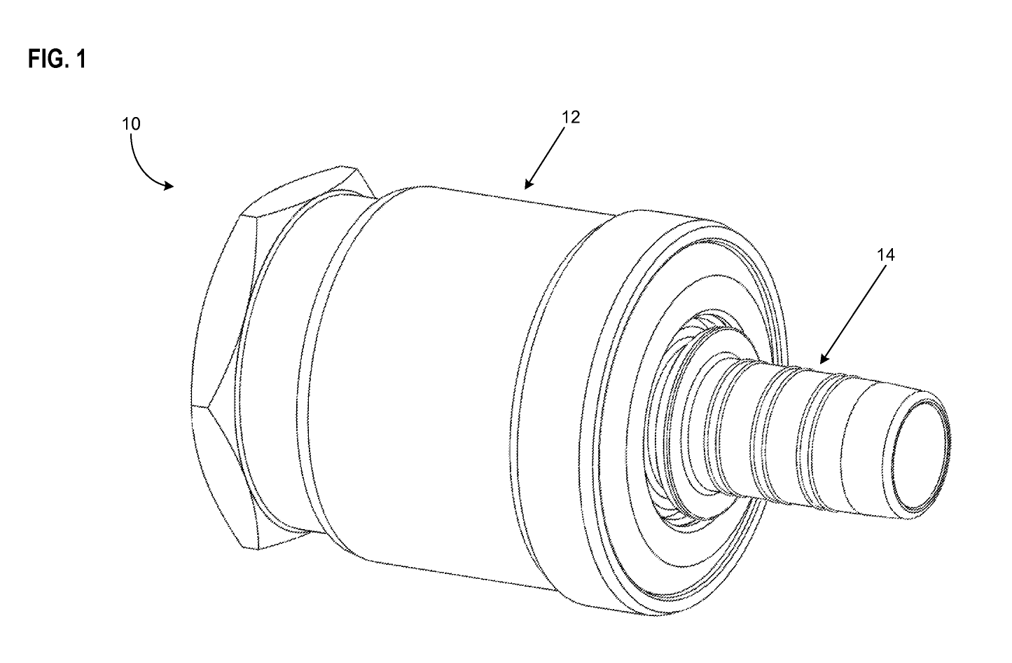

Referring now to FIG. 1, a fluid coupling assembly 10 is shown. The fluid coupling assembly 10 includes a socket assembly 12 and a plug 14. The socket assembly 12 and the plug 14 of the fluid coupling assembly 10 are adapted for selective engagement in order to provide a fluid passage through the fluid coupling assembly 10.

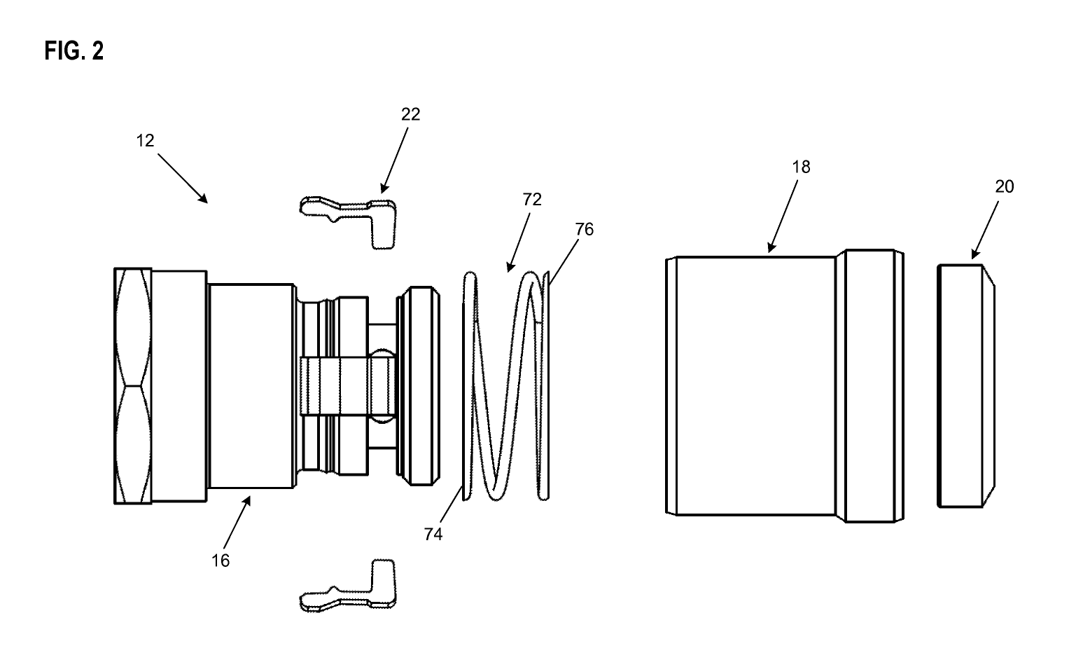

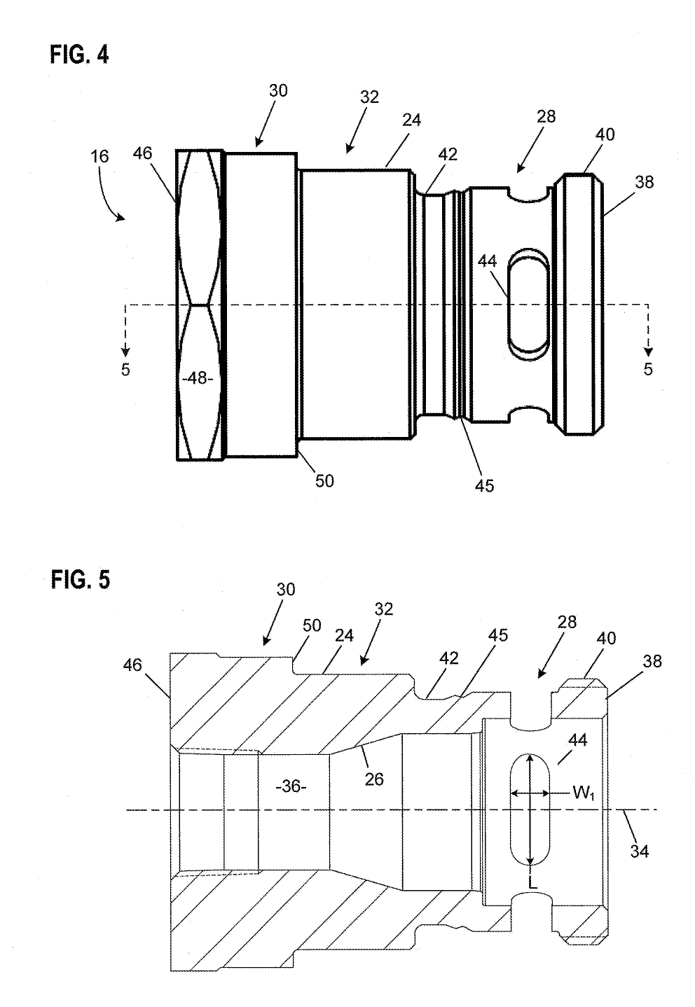

Referring now to FIGS. 2-5, the socket assembly 10 will be described. The socket assembly 10 includes a socket body 16, a socket sleeve 18, a fastener 20 and a plug retainer 22.

The socket body 16 includes an outer surface 24 and an inner surface 26. In the depicted embodiment, the outer surface 24 of the socket body 16 is generally cylindrical in shape.

The socket body 16 further includes a first portion 28, an oppositely disposed second portion 30 and a third portion 32 disposed between the first and second portions 28, 30. The socket body 16 defines a central longitudinal axis 34 that extends through the first, second and third portions 28, 30, 32. The inner surface 26 of the socket body 16 defines a bore 36 that extends along the central longitudinal axis 34 through the first, second and third portions 28, 30, 32. The bore 36 is adapted to convey fluid through the fluid coupling assembly 10.

The first portion 28 of the socket body 16 includes a first end surface 38. In the depicted embodiment, the first end surface 38 is generally perpendicular to the central longitudinal axis 34.

The outer surface 24 of the first portion 28 defines a plurality of external threads 40. In the depicted embodiment, the external threads 40 are disposed immediately adjacent to the first end surface 38.

The first portion 28 defines a recess 42 in the outer surface 24. In the depicted embodiment, the recess 42 is an annular recess. The first portion 28 further defines a plurality of retainer openings 44. In one embodiment, there is at least one retainer opening 44. In another embodiment, there are at least two retainer openings 44. In another embodiment, there are at least four retainer openings 44.

The plurality of retainer openings 44 is disposed between the plurality of external threads 40 and the recess 42 of the first portion 28. The retainer openings 44 extend through the outer and inner surfaces 24, 26 of the first portion 28 of the socket body 16 in a direction that is generally perpendicular to the central longitudinal axis 34. In the depicted embodiment, the retainer openings 44 are generally rectangular in shape. In another embodiment, the retainer openings 44 are generally obround in shape.

Each of the retainer openings 44 have a width W₁ that is measured in a direction that is generally parallel to the central longitudinal axis 34 and a length L that is measured in a direction that is generally perpendicular to the central longitudinal axis 34. In the depicted embodiment, the length L of the retainer openings 44 is greater than the width W₁.

The first portion 28 further defines a groove 45 disposed between the recess 42 and the plurality of retainer openings 44. In the depicted embodiment, the groove 45 extends circumferentially around the first portion 28 of the socket body 16.

The second portion 30 of the socket body 16 includes a second end surface 46. The second end surface 46 is oppositely disposed from the first end surface 38. In the depicted embodiment, second end surface 46 is generally parallel to the first end surface 38 but faces in a direction that is opposite to the first end surface 38.

A portion of the outer surface 24 of the second portion 30 of the socket body 16 includes a plurality of flats 48 disposed about the circumference of the outer surface 24. In the depicted embodiment, the plurality of flats 48 is disposed immediately adjacent to the second end surface 46. In one embodiment, the plurality of flats 48 is disposed in a hex nut configuration.

The third portion 32 of the socket body 16 includes a first spring seat 50. In the depicted embodiment, the first spring seat 50 is generally perpendicular to the central longitudinal axis 34. The first spring seat 50 is disposed between the first and second portions 28, 30 of the socket body 16.

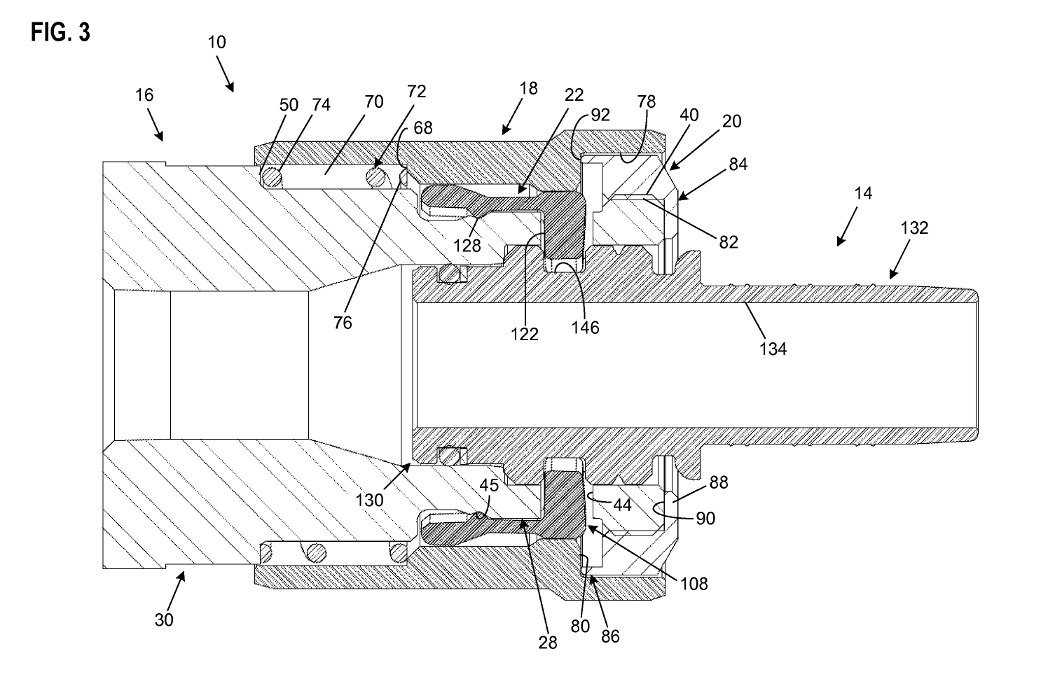

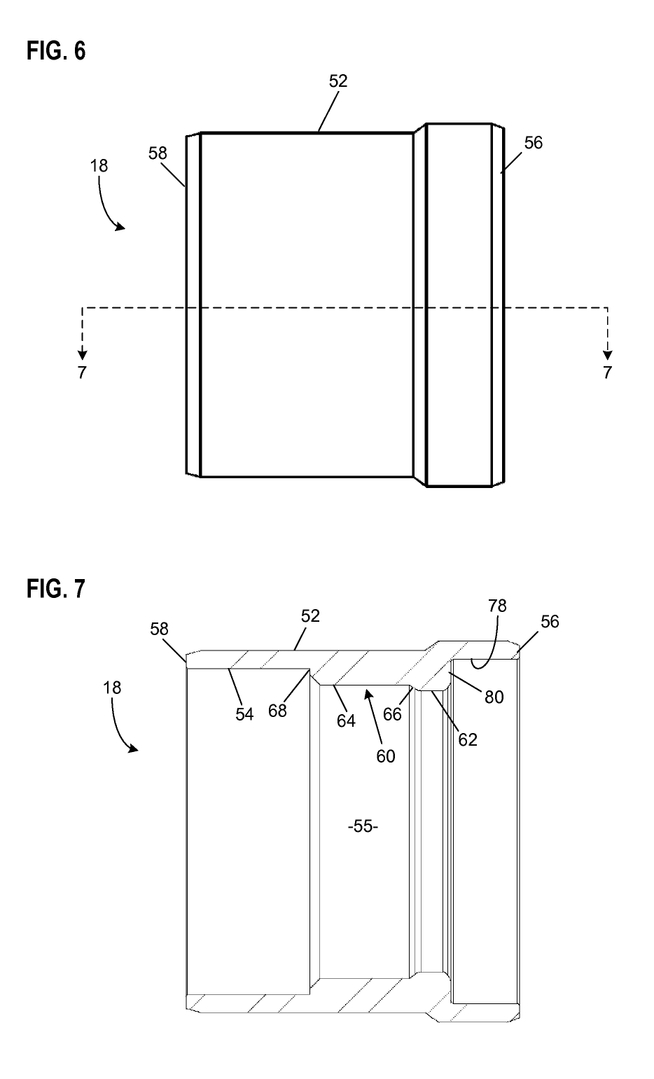

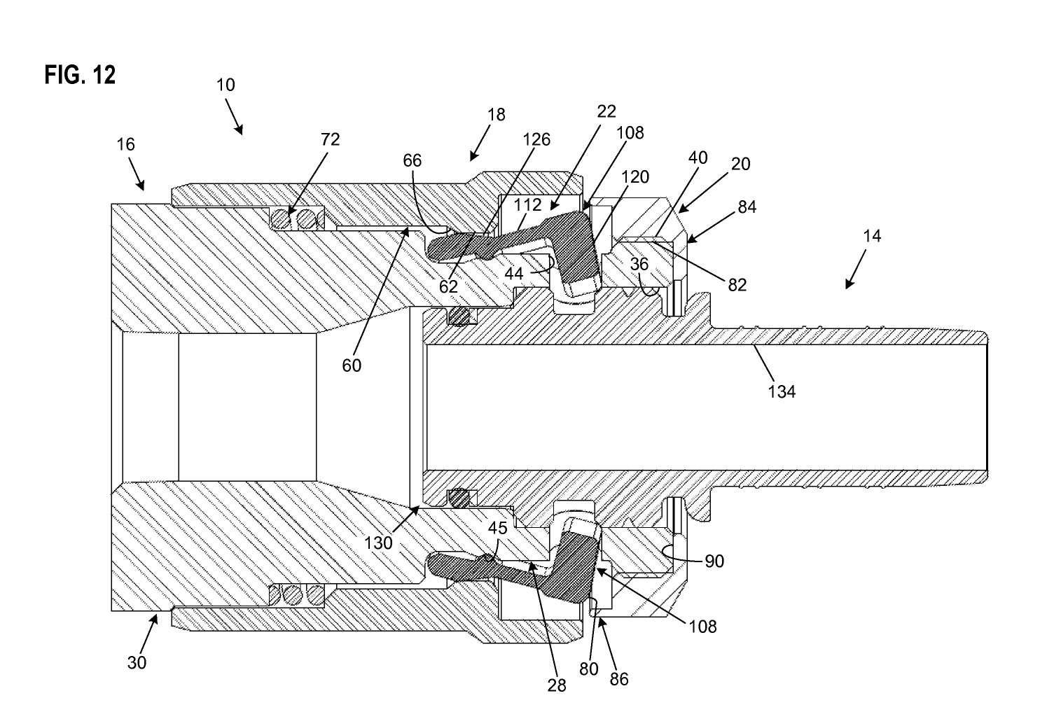

Referring now to FIGS. 2, 3, 6 and 7, the socket sleeve 18 will be described. The socket sleeve 18 is generally cylindrical in shape. The socket sleeve 18 is disposed about the socket body 16 and is adapted for axial movement in a direction that is generally parallel to the central longitudinal axis 34 of the socket body 16. The socket sleeve 18 moves between a first position (shown in FIG. 3) and a second position (shown in FIG. 12).

The socket sleeve 18 includes an exterior surface 52 and an interior surface 54. The interior surface 54 defines a passage 55 in which a portion of the socket body 16 is disposed.

The socket sleeve 18 includes a first axial end 56 and an oppositely disposed second axial end 58. In the depicted embodiment, the first and second axial ends 56, 58 are parallel. In the depicted embodiment, the first and second axial ends 56, 58 are generally perpendicular to the central longitudinal axis 34 when the socket body 16 is disposed in the socket sleeve 18.

The interior surface 54 includes a protrusion 60 that is disposed between the first and second axial ends 56, 58. The protrusion 60 extends radially inward toward the central longitudinal axis 34 of the socket body 16 when the socket body 16 is disposed in the socket sleeve 18. In the depicted embodiment, the protrusion 60 is an annular protrusion.

The protrusion 60 includes a first portion 62, a second portion 64 and an angled portion 66 disposed between the first and second portions 62, 64. In the depicted embodiment, an inner diameter of the first portion 62 of the protrusion 60 is less than an inner diameter of the second portion 64 of the protrusion 60. The angled portion 66 is a surface that extends between the first and second portions 62, 64. In the depicted embodiment, the angled portion 66 is disposed at an oblique angle.

The protrusion 60 of the socket sleeve 18 includes a second spring seat 68. The second spring seat 68 is generally perpendicular to the central longitudinal axis 34 of the socket body 16 when the socket body 16 is disposed in the socket sleeve 18. When the socket body 16 is disposed in the socket sleeve 18, the second spring seat 68 faces the first spring seat 50 of the socket body 16 so that the socket body 16 and the socket sleeve 18 cooperatively define a spring cavity 70 between the first and second spring seats 50, 68. The spring cavity 70 is adapted to receive a spring 72. The spring 72 includes a first end 74 that abuts the first spring seat 50 of the socket body 16 and an oppositely disposed second end 76 that abuts the second spring seat 68 of the socket sleeve 18 when the socket body 16 is disposed in the socket sleeve 18.

The socket sleeve 18 defines a fastener cavity 78. The fastener cavity 78 is defined immediately adjacent to the first axial end 56 of the socket sleeve 18. The socket sleeve 18 includes a fastener surface 80 disposed at the interface between the fastener cavity 78 and the protrusion 60. In the depicted embodiment, the fastener surface 80 is generally perpendicular to the central longitudinal axis 34 of the socket body 16 when the socket body 16 is disposed in the socket sleeve 18.

Referring now to FIG. 3, the socket assembly 10 includes the fastener 20. The fastener 20 is adapted to retain the sleeve 18 about the socket body 16 of the socket assembly 10. The fastener 20 includes a plurality of internal threads 82 that engages the plurality of external threads 40 of the socket body 16.

The fastener 20 includes a first end 84 and an oppositely disposed second end 86. In the depicted embodiment, the first and second ends 84, 86 are generally perpendicular to the central longitudinal axis 34 of the socket body 16 when the fastener 20 is engaged to the socket body 16.

The fastener 20 includes a lip 88 at the first end 84. The lip 88 extends radial inward so that an inner diameter of the lip 88 is less than an inner diameter of the internal threads 82. The lip 88 includes an abutment surface 90 that faces toward the internal threads 82.

The second end 86 of the fastener 20 includes an end surface 92 that is immediately adjacent to the internal threads 82. The end surface 92 is oppositely disposed from the lip 88 so that the internal threads 82 are between the end surface 92 and the lip 88.

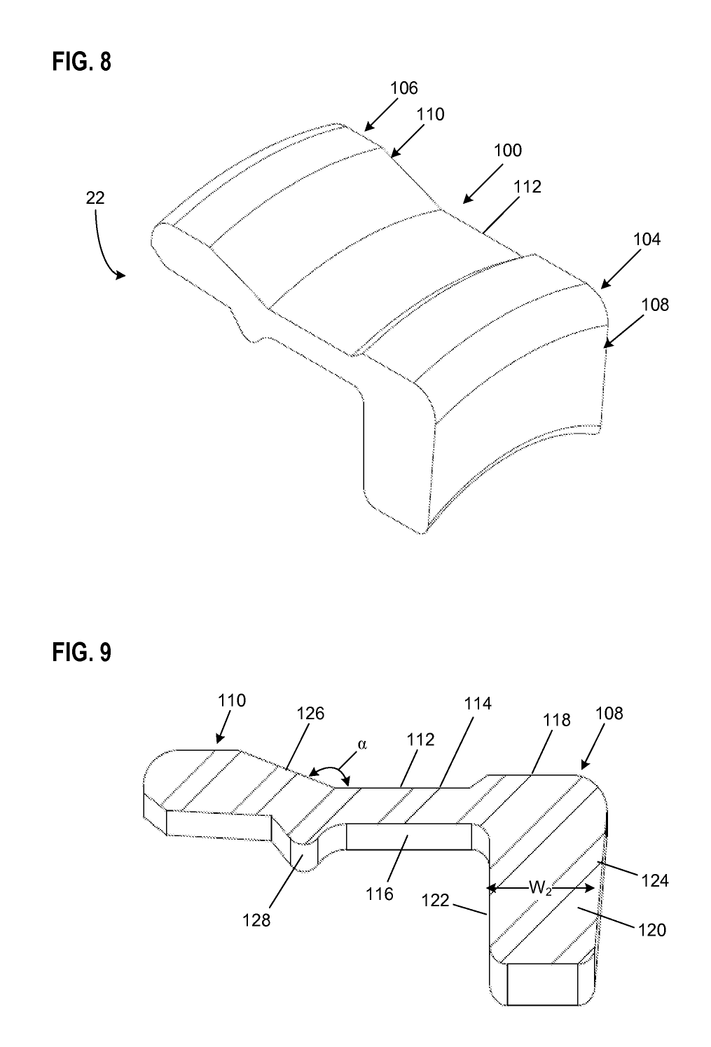

Referring now to FIGS. 3, 8 and 9, the plug retainer 22 is shown. The plug retainer 22 is adapted to engage the outer surface 24 of the socket body 16. The plug retainer 22 is further adapted to selectively pivot between an engaged position (shown in FIG. 3) and a disengaged position (shown in FIG. 12). In the engaged position, the plug retainer 22 prevents the plug 14 from being removed from the socket assembly 12. In the disengaged position, the plug retainer 22 allows the plug 14 to be removed from the socket assembly 12.

The plug retainer 22 includes a body 100. The body 100 of the plug retainer 22 includes a first end 104 and an oppositely disposed second end 106. The body 100 includes a retainer 108 disposed at the first end 104 of the body 100, a lever 110 disposed at the second end 106 and a central portion 112 connecting the retainer 108 and the lever 110.

The body 100 includes an outer surface 114 and an inner surface 116. In the depicted embodiment, the outer surface 114 of the body 100 is generally convex in shape while the inner surface 116 is generally concave in shape.

The retainer 108 includes a retainer head 118 and a retainer body 120. The retainer head 118 is a small protrusion that extends outwardly from the outer surface 114 of the body 100. The retainer body 120 extends outwardly from the inner surface 116 of the body 100. In the depicted embodiment, the retainer body 120 extends from the concave surface of the body 100. In the depicted embodiment, the retainer body 120 extends from the body 100 in a generally perpendicular direction.

The retainer body 120 includes a first retention surface 122 and an oppositely disposed second retention surface 124. The first retention surface 122 faces in a direction toward the lever 110. The second retention surface 124 faces in a direction opposite the first retention surface 122. In the depicted embodiment, the second retention surface 124 is disposed at an oblique angle with respect to the first retention surface 122 so that a width W₂ of the retainer body 120 gets narrower as the retainer body 120 extends outward from the inner surface 116 of the body 100. The width W₂ of the retainer body 120 is less than the width W₁ of the retention opening 44 of the socket body 16.

The lever 110 is disposed at the second end 106 of the body 100 and extends outwardly from the central portion 112 of the body 100. The lever 110 includes a cam surface 126. The cam surface 126 is disposed on the outer surface 114 of the lever 110. The cam surface 126 opens outwardly in a direction away from the central portion 112 of the body 100. The cam surface 126 is disposed at an oblique angle a with respect to the central portion 112 of the body 100.

The plug retainer 22 includes a fulcrum 128 about which the plug retainer 22 pivots when disposed on the outer surface 24 of the socket body 16. In the depicted embodiment, the fulcrum 128 extends outwardly from the inner surface 116 of the body 100 of the plug retainer 22. In the depicted embodiment, the fulcrum 128 is seated in the groove 45 of the first portion 28 of the socket body 16. With the fulcrum 128 disposed in the groove 45, a portion of the retainer body 120 of the retainer 108 is disposed in the retainer opening 44 of the socket body 16.

Referring now to FIG. 3, the assembly of the socket assembly 12 will be described. At least one plug retainer 22 is disposed against the socket body 16 so that a portion of the retainer 108 of the plug retainer 22 is disposed in the retainer opening 44 of the socket body 16. In the depicted embodiment, the fulcrum 128 of the plug retainer 22 is disposed in the groove 45 of the socket body 16.

The spring 72 is disposed over the first portion 28 of the socket body 16 so that the first end 74 of the spring 72 abuts the first spring seat 50 of the socket body 16. The first portion 28 of the socket body 16, the at least one plug retainer 22 and the spring 72 are inserted into the passage 56 of the socket sleeve 18 so that the second end 76 of the spring 72 abuts the second spring seat 68 of the socket sleeve 18.

The socket sleeve 18 is then pushed in a direction toward the second portion 30 of the socket body 16 so that the spring 72 is compressed. With the socket sleeve 18 pushed toward the second portion 30 of the socket body 16, the fastener 20 is engaged to the first portion 28 of the socket body 16. In the depicted embodiment, the internal threads 82 of the fastener 20 are threadedly engaged to the external threads 40 of the socket body 16 until the first end surface 38 of the socket body 16 abuts the abutment surface 90 of the lip 88 of the fastener 20.

With the fastener 20 engaged to the socket body 16, the socket sleeve 18 can be released. When the socket sleeve 18 is released, the spring 72 biases the socket sleeve 18 into the first position. In depicted embodiment, the fastener surface 80 of the socket sleeve 18 abuts the end surface 92 of the fastener 20 when the socket sleeve 18 is in the first position.

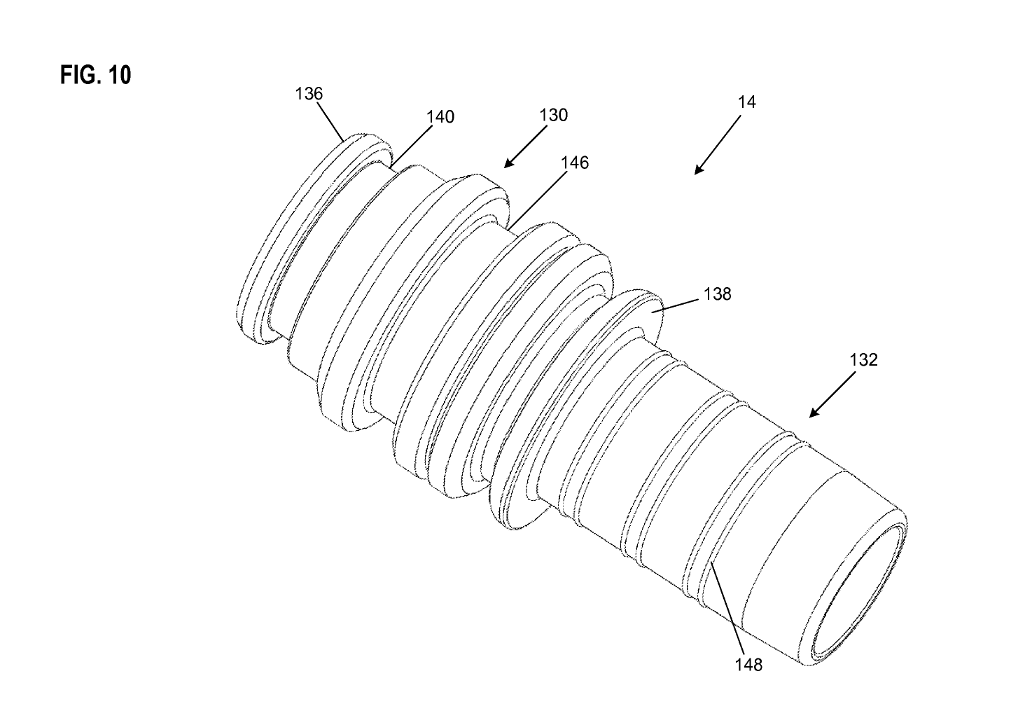

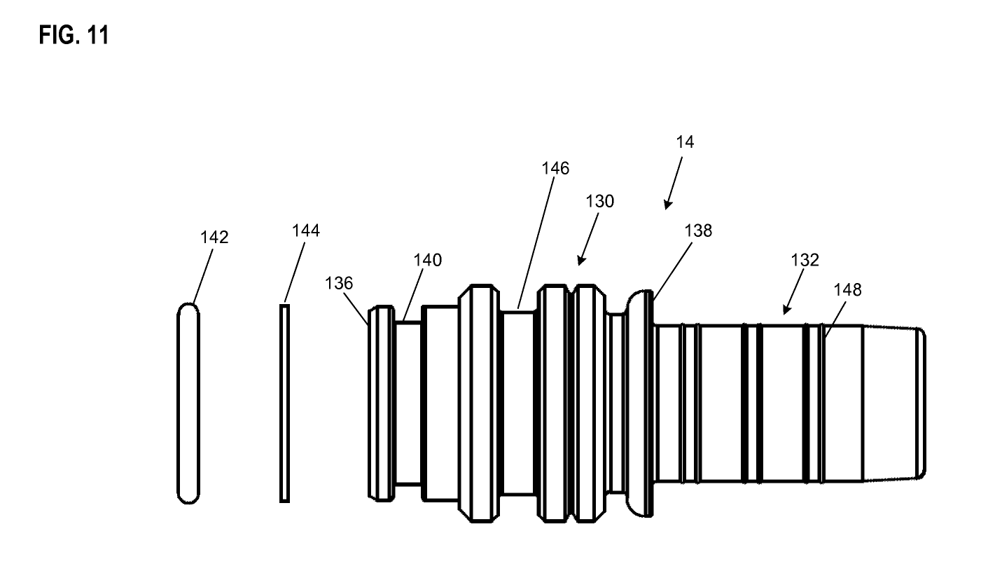

Referring now to FIGS. 3, 10 and 11, the plug 14 is shown. The plug 14 is a conventional plug that is manufactured in accordance with specification SAE J1467:(R) Clip Fastener Fitting, Standard and DIN 20043 Staple-lock Couplings for Hydraulic Power-Transmission Circuits.

The plug 14 includes a first end portion 130 and an oppositely disposed second end portion 132. The plug 14 defines a fluid passage 134 (shown in FIG. 3) that extends through the first and second end portions 130, 132.

The first end portion 130 includes first axial end 136 and a hose stop 138. The hose stop 138 is adapted to abut an end of a hose when the second end portion 132 of the plug 14 is inserted into a bore of the hose.

The first end portion 130 of the plug 14 defines a seal groove 140 disposed adjacent to the first axial end 136. The seal groove 140 receives a seal 142 to prevent leakage between the plug 14 and the passage 56 of the socket body 16. In the depicted embodiment, the seal groove 140 also receives a backup washer 144.

The first end portion 130 of the plug 14 further defines a retention groove 146 disposed between the seal groove 140 and the stop 138. The retention groove 146 is sized to selectively receive a portion of the retainer body 120 of the retainer 108 of the plug retainer 22.

In the depicted embodiment, the second end portion 132 includes a plurality of ribs 148. The ribs 148 are adapted to engage a bore of the hose when the second end portion 132 is inserted into the bore of the hose. After the second end portion 132 is inserted into the bore of the hose, the hose is crimped to the second end portion 132 of the plug 14. With the hose crimped to the second end portion 132 of the plug 14, the ribs 148 provide resistance against disassembly of the plug 14 and the hose.

Referring now to FIGS. 3 and 12, a method for coupling the socket assembly 12 and the plug 14 will be described. The socket sleeve 18 of the socket assembly 12 is actuated to the second position. To actuate the socket sleeve 18 to the second position, the socket sleeve 18 is pushed in a direction toward the second portion 30 of the socket body 16 against a force of the spring 72. As the socket sleeve 18 moves toward the second portion 30 of the socket body 16, the angled portion 66 of the protrusion 60 of the socket sleeve 18 contacts the cam surface 126 of the plug retainer 22 causing the plug retainer 22 to pivot from the engaged position to the disengaged position. In the disengaged position, the retainer body 120 is disposed in the retainer opening 44 of the socket body 16 so that the retainer body 120 does not penetrate into the bore 36 of the socket body 16. In the depicted embodiment, the lever 110 of the plug retainer 22 is disposed in the recess 42 when the plug retainer 22 is in the disengaged position.

With the plug retainer 22 in the disengaged position, the first end portion 130 of the plug 14 is inserted into the bore 36 of the socket body 16. When the first end portion 130 of the plug 14 is fully inserted into the bore 36, the retention groove 146 of the plug 14 is generally aligned with the retainer openings 44. With the first end portion 130 of the plug 14 inserted in the bore 36 of the socket body 16, the socket sleeve 18 is released. The spring 72 biases the socket sleeve 18 to the first position. As the socket sleeve 18 moves to the first position, the first portion 62 of the projection 60 contacts the central portion 112 of the plug retainer 22 causing the plug retainer 22 to pivot from the disengaged position to the engaged position. In the engaged position, the retainer body 120 is disposed in the retainer opening 44 of the socket body 16 so that a portion of the retainer body 120 extends into the retention groove 146 of the plug 14.

With the socket sleeve 18 in the first position, the protrusion 60 is disposed on or above the retainer head 118 of the plug retainer 22, which prevents the plug retainer 22 from being inadvertently disengaged. With the plug retainer 22 in the engaged position, the plug 14 is prevented from being removed from the bore 36 of the socket body 16 by the abutment of the first retention surface 122 of the retainer 108 of the plug retainer 22 and an opposing surface in the retention groove 146 of the plug 14.

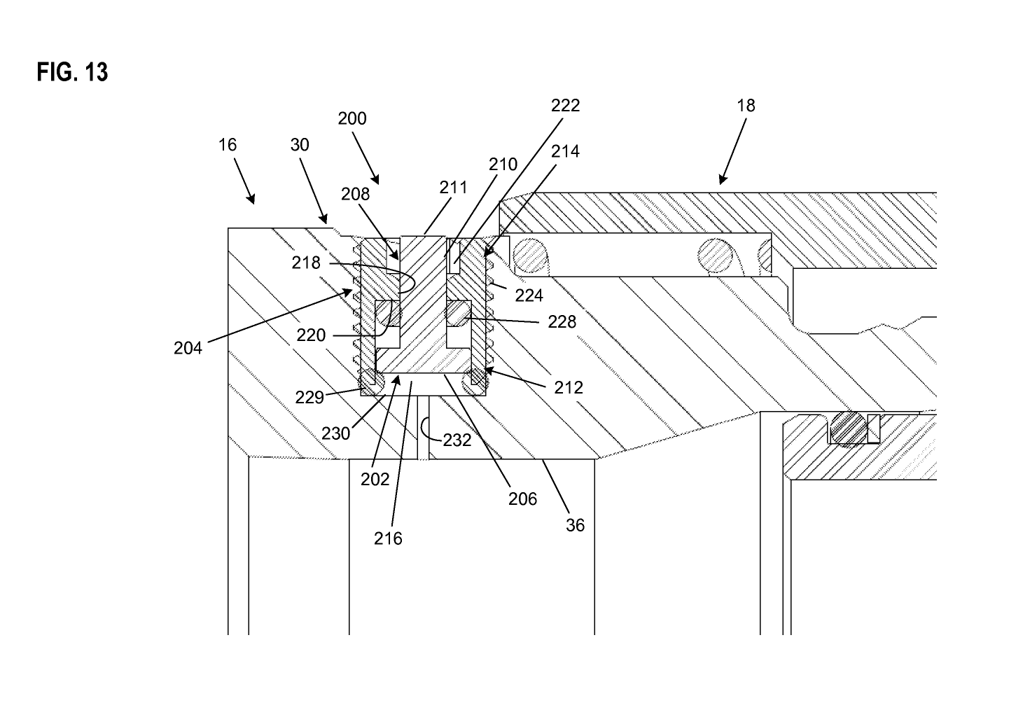

Referring now to FIG. 13, a sleeve lock 200 is shown in the socket body 16. The sleeve lock 200 is adapted to provide a visual indication that there is pressurized fluid in the bore 36 of the socket body 16 and to prevent the socket sleeve 18 from being actuated to the second position when fluid is passing through the fluid coupling assembly 10. The sleeve lock 200 includes a piston 202 and a piston housing 204.

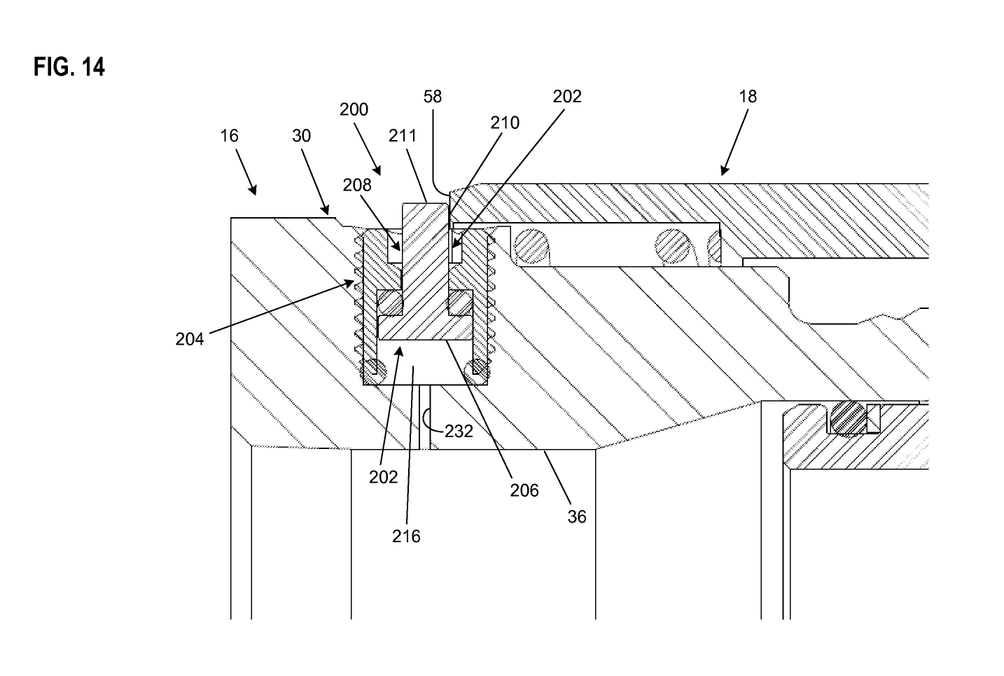

The piston 202 is adapted for axial movement in the piston housing 204 between an unlocked position (shown in FIG. 13) and a locked position (shown in FIG. 14). The piston 202 includes a piston head 206 and a piston rod 208 that extends outwardly from the piston head 206. The piston head 206 is generally cylindrical in shape. The piston head 206 has an outer diameter that is greater than an outer diameter of the piston rod 208. The piston rod 208 includes an outer surface 210 and a piston end 211. In one embodiment, the outer surface 210 has a first color that is different than the color of the piston housing 204.

The piston housing 204 includes a first end 212 and an oppositely disposed second end 214. The first end 212 defines a piston cavity 216. The piston cavity 216 is adapted to receive the piston head 206 of the piston 202.

The second end 214 defines a rod opening 218 that is adapted to receive the piston rod 208 of the piston 202. The rod opening 218 extends from the piston cavity 216 through the second end 214. The rod opening 218 has an inner diameter that is less than an inner diameter of the piston cavity 216. A shoulder 220 is disposed at the interface of the piston cavity 216 and the rod opening 218.

In the depicted embodiment, the second end 214 further defines a recess 222. In the depicted embodiment, the recess 222 is a hex shaped recess that is generally coaxial with the rod opening 218. The recess 222 is adapted to receive a tool that can be used to insert the sleeve lock 200 in the socket body 16.

The piston housing 204 includes an outer surface 224. In the depicted embodiment, the outer surface 224 of the piston housing 204 includes a plurality of external threads.

The sleeve lock 200 further includes a piston seal 228 and a piston housing seal 229. The piston seal 228 is disposed in the piston cavity 216 at the shoulder 220. The piston seal 228 is adapted to seal against the piston rod 208. The piston housing seal 229 is disposed at the first end 212 of the piston housing 204. The piston housing seal 229 is adapted to prevent fluid from leaking between the piston housing 204 and the socket body 16.

The second portion 30 of the socket body 16 defines a lock bore 230. The lock bore 230 is adapted to receive the sleeve lock 200. The lock bore 230 is positioned in the second portion 30 of the socket body 16 so that the sleeve lock 200 is exposed (i.e., visible) when the socket sleeve 18 is disposed in the first position. In the depicted embodiment, the piston rod 208 is completely unobstructed by the socket sleeve 18 when the socket sleeve 18 is in the first position.

The lock bore 230 includes an inner surface. In the depicted embodiment, the inner surface of the lock bore 230 defines a plurality of internal threads that is adapted for engagement with the plurality of external threads of the piston housing 204.

The second portion 30 of the socket body 16 further defines a fluid passage 232. The fluid passage 232 provides fluid communication between the bore 36 of the socket body 16 and the lock bore 230 of the socket body 16.

Referring now to FIGS. 13 and 14, the operation of the sleeve lock 200 will be described. When the bore 36 of the socket body 16 does not contain pressurized fluid, the piston 202 is disposed in the unlocked position (shown in FIG. 13). In the unlocked position, the piston end 211 does not extend beyond the outer surface 24 of the second portion 30 of the socket body 16. In the unlocked position, the socket sleeve 18 can be actuated to the second position so that the plug 14 can be disengaged from the socket assembly 12.

When the plug 14 is engaged to the socket assembly 12 and pressurized fluid is disposed in the bore 36 of the socket body 16, the pressurized fluid passes through the fluid passage 232 and into the piston cavity 216 of the sleeve lock 200. The pressurized fluid in the piston cavity 216 acts against the piston head 206 of the piston 202 causing a portion of the piston rod 208 of the piston 202 to extend from the piston housing 204. With the piston 202 extended, a portion of the piston rod 208 extends beyond the outer surface 24 of the second portion 30 of the socket body 16. As the piston rod 208 is completely visually unobstructed when the socket sleeve 18 is in the first position, the extension of the piston 202 provides a visual indicator to an operator that there is pressurized fluid in the hose and that the plug 14 should not be disconnected from the socket assembly 12. In addition, with a portion of the piston rod 208 of the piston 202 extended beyond the outer surface 24 of the second portion 30 of the socket body 16, the socket sleeve 18 cannot be actuated to the second position since the second axial end 58 of the socket sleeve 18 abuts the outer surface 210 of the piston rod 208 before the socket sleeve 18 can be fully actuated to the second position.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A fluid coupling assembly comprising:
a plug having a first end portion and a second end portion, the first end portion defining a retention groove;
a socket assembly adapted for selective engagement with the plug, the socket assembly including:
a socket body defining a bore that extends through the socket body and at least one retention opening that extends into the bore, wherein the at least one retention opening is generally aligned with the retention groove when the first end portion of the plug is inserted into the bore of the socket body; and
a plug retainer operably associated with the socket body, the plug retainer having a body including a retainer, wherein the plug retainer pivots between an engaged position, in which a portion of the retainer is disposed in the retention groove of the plug, and a disengaged position, in which the retention groove of the plug is free of the portion of the retainer.

2. The fluid coupling assembly as claimed in claim 1, wherein the body of the plug retainer includes a lever disposed oppositely from the retainer.

3. The fluid coupling assembly as claimed in claim 4, wherein the lever includes a cam surface that is disposed at an oblique angle from the central portion.

4. The fluid coupling assembly as claimed in claim 1, wherein the plug retainer includes an inner surface, the inner surface including a fulcrum about which the plug retainer pivots.

5. The fluid coupling assembly as claimed in claim 1, further comprising a socket sleeve disposed about the socket body, the socket sleeve being adapted for selective axial movement between a first position and a second position, wherein the socket sleeve actuates the plug retainer to the engaged position in the first position and the disengaged position in the second position.

6. The fluid coupling assembly as claimed in claim 5, wherein the socket sleeve contacts a lever of the plug retainer to pivot the plug retainer to the disengaged position.

7. The fluid coupling assembly as claimed in claim 5, further comprising a sleeve lock disposed in the socket body and being in fluid communication with the bore, the sleeve lock including a piston that extends beyond an outer surface of the socket body in response to pressurized fluid in the bore of the socket body, wherein abutment of the piston and the socket sleeve prevent actuation of the socket sleeve to the second position when pressurized fluid is in the bore of the socket body.

8. The fluid coupling assembly as claimed in claim 7, wherein the sleeve lock is visible when the socket sleeve is in the first position.

9. A socket assembly of a fluid coupling assembly comprising:
a socket body having an inner surface and an outer surface, the inner surface defining a bore that extends through the socket body, the outer surface defining at least one retention opening that extends through the outer and inner surfaces;
a plug retainer operably associated with the socket body, the plug retainer including a retainer, a portion of which is disposed in the retention opening of the socket body, wherein the plug retainer pivots between an engaged position, in which a portion of the retainer is disposed in the bore of the socket body, and a disengaged position, in which the bore is free of the portion of the retainer; and
a socket sleeve disposed about the socket body, the socket sleeve being adapted for selective axial movement between a first position and a second position, wherein the socket sleeve actuates the plug retainer to the engaged position in the first position and the disengaged position in the second position.

10. The socket assembly as claimed in claim 9, wherein the body of the plug retainer includes a lever disposed oppositely from the retainer.

11. The socket assembly as claimed in claim 10, wherein the body includes a central portion disposed between the lever and retainer.

12. The socket assembly as claimed in claim 11, wherein the lever includes a cam surface that is disposed at an oblique angle from the central portion.

13. The socket assembly as claimed in claim 9, wherein the plug retainer includes an inner surface, the inner surface including a fulcrum about which the plug retainer pivots.

14. The socket assembly as claimed in claim 9, further comprising a sleeve lock disposed in the socket body and being in fluid communication with the bore, the sleeve lock including a piston that extends beyond an outer surface of the socket body in response to pressurized fluid in the bore of the socket body, wherein abutment of the piston and the socket sleeve prevent actuation of the socket sleeve to the second position when pressurized fluid is in the bore of the socket body.

15. The socket assembly as claimed in claim 14, wherein the sleeve lock is exposed when the socket sleeve is in the first position.

16. A socket assembly of a fluid coupling assembly comprising:
a socket body having an outer surface, a first portion and an oppositely disposed second portion, the socket body defining a bore that extends axially through the socket body;
a socket sleeve disposed about the socket body, the socket sleeve having a first axial end and an oppositely disposed second axial end, the socket sleeve being adapted for selective axial movement between a first position and a second position, wherein the outer surface of the second portion of the socket body is exposed when the socket sleeve is in the first position; and
a sleeve lock disposed in the second portion of the socket body and in fluid communication with the bore of the socket body, the sleeve lock including a piston that extends beyond the outer surface of the second portion in response to pressurized fluid in the bore of the socket body, wherein abutment of the piston and the second axial end of the socket sleeve prevents actuation of the socket sleeve to the second position when pressurized fluid is in the bore of the socket body.

17. The socket assembly of claim 16, wherein sleeve lock includes a piston housing disposed in a lock bore of the socket body, the piston housing having a first end and an oppositely disposed second end, the first end defining a piston cavity in fluid communication with the socket bore.

18. The socket assembly of claim 17, wherein the second end of the piston housing defines a rod opening through which a piston rod of the piston passes.

19. The socket assembly of claim 18, wherein the second end of the piston housing further defines a recess that is generally coaxial with the rod opening.

20. The socket assembly of claim 19, wherein the recess is hexagonal in shape.
